(19) United States
(12) Patent Application Publication
(10) Pub. No.: US 2007/0182972 A1
(43) Pub. Date: Aug. 9, 2007

(54) Image processing system for printers and method of the same

(75) Inventors: Guo-Tai Chen, Taipei (TW); Hui-Jan Chien, Taipei (TW)

Correspondence Address: BRUCHE H. TROXELL, SUITE 1404, 5205 LEESBURG PIKE, FALLS CHURCH, VA, 22041, US

(73) Assignee: Destiny Technology Corporation

(21) Appl. No.: 11/346,282

(22) Filed: Feb. 3, 2006

(51) Int. Cl. G06K 15/02

(52) U.S. Cl. 358/1.2; 358/3.06

(57) ABSTRACT

The present invention relates to a set of image processing method and systems to be used in printers with asymmetrical-resolution printing mode. The asymmetrical-resolution is defined as having an aspect ratio of n=X:Y. The system first picks up a symmetrical-resolution halftone table and then, by making use of an algorithm such as an interpolation such as a B-spline method, expand the symmetrical-resolution halftone table by n times along the width direction to obtain an asymmetrical-resolution halftone table, in accordance with which the system will subsequently do the necessary pre-print processing of halftoning in order to print out the corresponding image(s).

### BACKGROUND OF THE INVENTION

1. Field of the Invention

The present invention relates to an image processing method and system, particularly to image processing method and system for using in a printer having an asymmetrical-resolution.

2. Description of the Prior Art

Generally speaking, before actual print-out, a printer has to do some pre-print processing known as halftoning to assimilate and convert the image data it has just received. There are two kinds of halftoning techniques related to this preprinting process: AM (Amplitude Modulation) and FM (Frequency Modulation). With the AM technique, the size of printer toner dots varies with the tone of the image, whereas with the FM technique, the dot size is fixed, it is the varied spacing between the dots that decides the tone of the image. The AM technique is generally used with laser printers, while the FM technique is used with ink jet printers.

An image is thus constituted by a plurality of densely clustered pixels, each pixel having a corresponding gray scale value ranging from 0 to 255.

Halftoning is done by converting the data contained in each pixel of the image according to a halftone table, formed by the directional characteristics of the four printing colors: C [symbol] M [symbol] Y [symbol] K, which is a prior art technique of which we will not make more description than is necessary.

To illustrate, the following is a table which contains all the data corresponding to an image. Each grid represents a pixel and its corresponding gray scale value.

TABLE 1

| | | | | | |
|---|---|---|---|---|---|
| 32 | 25 | 100 | 10 | . . . | . . . |
| . . . | . . . | . . . | . . . | . . . | . . . |
| . . . | . . . | . . . | . . . | . . . | . . . |
| . . . | . . . | . . . | . . . | . . . | . . . |
| . . . | . . . | . . . | . . . | . . . | . . . |
| . . . | . . . | . . . | . . . | . . . | . . . |

Table 2 is a symmetric resolution halftone table containing a plurality of corresponding values.

TABLE 2

| | | | | | |
|---|---|---|---|---|---|
| 50 | 3 | 101 | . . . | . . . | . . . |
| . . . | . . . | . . . | . . . | . . . | . . . |
| . . . | . . . | . . . | . . . | . . . | . . . |
| . . . | . . . | . . . | . . . | . . . | . . . |
| . . . | . . . | . . . | . . . | . . . | . . . |
| . . . | . . . | . . . | . . . | . . . | . . . |

By comparing the corresponding grids of Table 1 with those of Table 2, we obtain Table 3. When the grey scale value of a grid in Table 1 is smaller than the halftone value in the corresponding grid of Table 2, the corresponding grid of Table 3 is assigned a value of 0. When the grey scale value of a grid in Table 1 is lager than the halftone value in the corresponding grid of Table 2, the corresponding grid of Table 3 is assigned a value of 1. Thus, values in Table 3, from top left to bottom right, will run as follows: 0(32<50), 1 (25>3), 0 (100<101) . . . and so on.

TABLE 3

| | | | | | |
|---|---|---|---|---|---|
| 0 | 1 | 0 | . . . | . . . | . . . |
| . . . | . . . | . . . | . . . | . . . | . . . |
| . . . | . . . | . . . | . . . | . . . | . . . |
| . . . | . . . | . . . | . . . | . . . | . . . |
| . . . | . . . | . . . | . . . | . . . | . . . |
| . . . | . . . | . . . | . . . | . . . | . . . |

The printer will, according to the value received being 0 or 1, decide to print or not to print, hence forming the picture to be printed.

Please refer to FIG. 1. FIG. 1 illustrates what a prior art symmetrical resolution printer prints. By using symmetrical resolution halftone table to do pre-print processing, This kind of printers obtain ideal images that are symmetrical in all the four directions (up/down and right/left).

However, most printers nowadays are printers with such asymmetrical resolution as 1200*600 dpi, 2400*600 dpi, etc., If such printers use the aforesaid symmetrical resolution halftone table for pre-print processing, the printed result will be as FIG. 2 shows.

FIG. 2 illustrates what kind of image a prior art asymmetrical resolution printer will get using a symmetrical resolution halftone table to do its pre-print processing. The image 4 shows that the printed dots distort into elliptical shapes, greatly affecting the printing quality.

The purpose of this invention is thus to provide an image processing method and system for asymmetrical resolution printers so that the above problem may be solved.

### SUMMARY OF THE INVENTION

The purpose of the present invention is to provide an image processing method and system for a printer with asymmetrical-resolution to print out quality images.

The present invention relates to a set of image processing systems used in printers with asymmetrical resolution; the data received by the printer is halftoned according to a table so as to print out the corresponding images. The aforementioned asymmetrical-resolution has an aspect ratio of n=X:Y, with X being the width of the windows and Y being the height of the windows t, and the aforementioned pre-print processing, the halftoning process, is to be used with the AM(Amplitude Modulation) techniques of laser printers. Also, the image processing comprises a computation/conversion module.

Referring to a halftone table, the computation/conversion module will, by making use of an algorithm, expand the image's corresponding data on the symmetrical-resolution halftone table along width direction by n times, and, hence, acquire the desired asymmetrical-resolution halftone table.

The asymmetrical-resolution printer then goes on to do the pre-print processing of halftoning according to the asymmetrical-resolution halftone table so as to print out ideal images.

One more thing to add: the image processing system comprises a placement module, whose function is to distribute a plurality of densely clustered symmetrical-resolution halftone table over an image data's corresponding part in the image.

Subsequently, the module picks up from those symmetrical-resolution halftone tables a symmetrical-resolution halftone table as a chosen symmetrical-resolution halftone table as well as those symmetrical-resolution halftone tables around this chosen symmetrical-resolution halftone table, which the computation/conversion module will then use the aforementioned algorithm to expand into asymmetrical-resolution halftone tables.

The algorithm described above can be an interpolation such as a B-spline method or the like. The computation/conversion module first picks up from the chosen symmetrical-resolution halftone table two neighboring pixels, get an average value out of the two pixels' grayscale value, and then interpolate the value between the two pixels.

Thus, according to an image processing system and method for asymmetrical-resolution printers of the present invention, the printer's system can properly convert symmetrical-resolution halftone tables into asymmetrical-resolution halftone tables, which the system will use to do the pre-print processing so as to print out ideal images.

### BRIEF DESCRIPTION OF THE DRAWINGS

The following detailed descriptions and drawings will further illustrate the features and benefits of the present invention.

FIG. 1 shows the typical image printed using symmetrical-resolution printing mode in accordance with a prior art symmetrical-resolution printer.

FIG. 2 shows the typical image printed using symmetrical-resolution printing mode in accordance with a prior art symmetrical-resolution printer.

FIG. 3 shows image processing system in accordance with the present invention.

FIG. 4 shows symmetrical-resolution halftone tables are pasted in an image in accordance with the present invention.

FIG. 5 shows an image processing flow chart in accordance with an image processing system of the present invention.

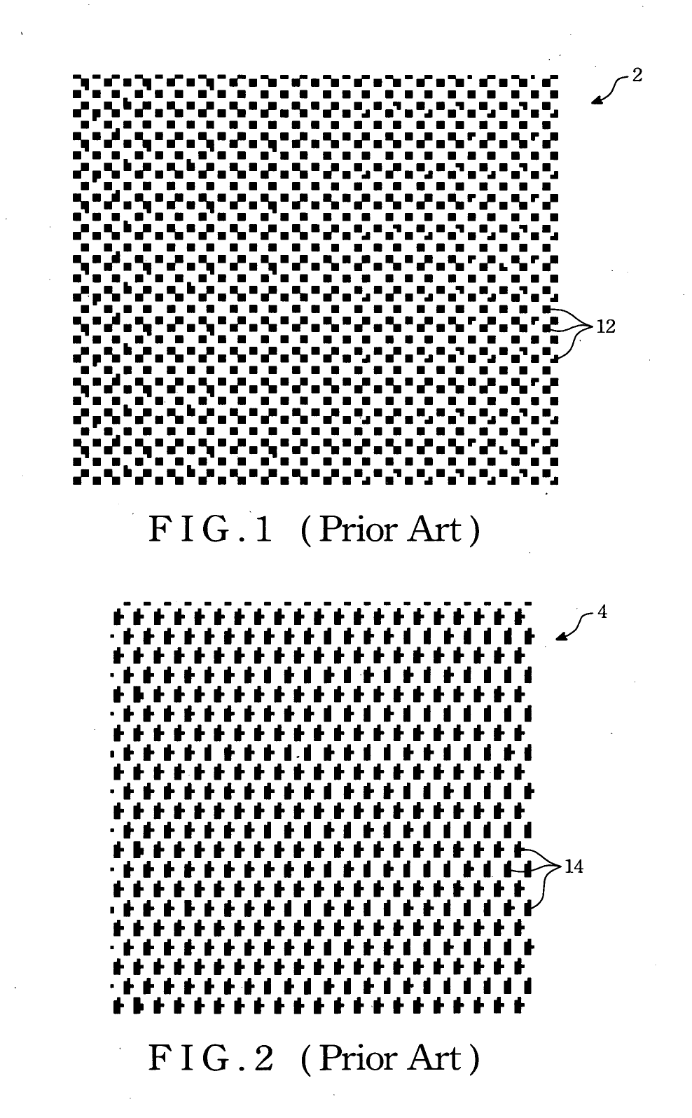

### DESCRIPTION OF THE PREFERRED EMBODIMENT

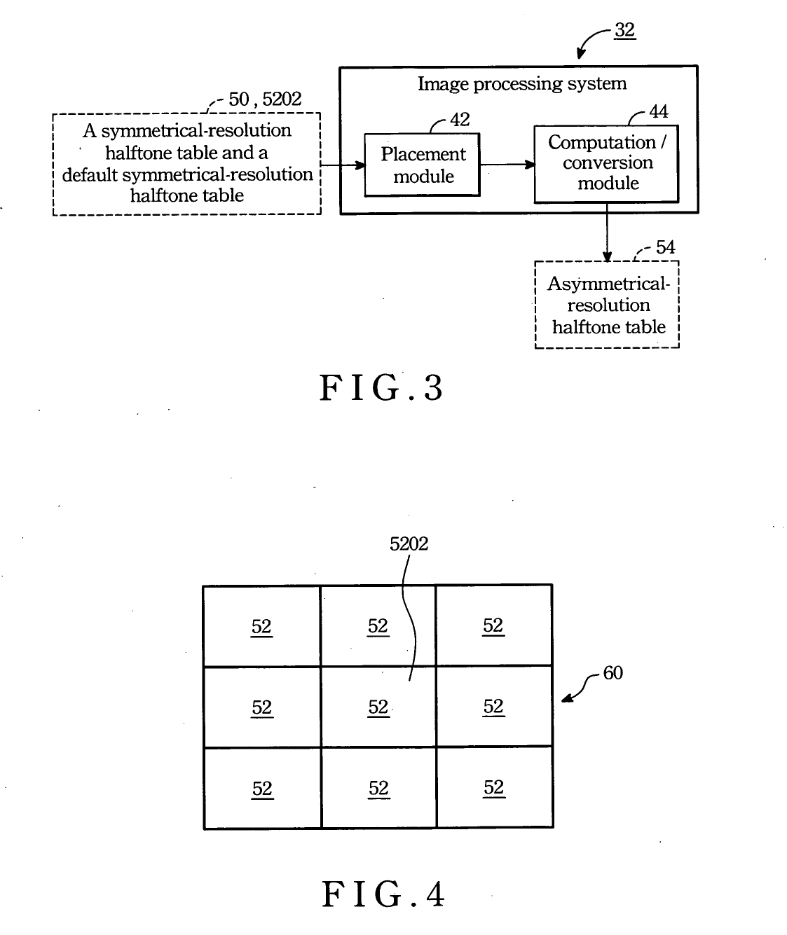

Please refer to FIG. 3. FIG. 3 illustrates how an image processing system 32 works according to the present invention. The present invention relates to an image processing system 32 used in printers whose printing resolutions are asymmetrical (e.g. 1200*600 dpi). Image data are received by the system and halftoned before their corresponding images are printed out. The aspect ratio of the asymmetrical-resolution mentioned above is represented by the function of: n=X:Y.

The pre-print processing of halftoning as mentioned in the above is of the AM (Amplitude Modulation) type, a technique generally used with laser printers. The image processing system 32 comprises a placement module 42 and a computation/conversion module 44.

The system first picks up a symmetrical-resolution halftone table 52, as FIG. 4 shows. The placement module 42 then distribute a plurality of densely clustered symmetrical-resolution halftone table 52 (arranged in dot matrices) over an image data's corresponding part in the image 60.

Subsequently, the module picks up from those symmetrical-resolution halftone tables a symmetrical-resolution halftone table as a chosen symmetrical-resolution halftone table 5202 as well as those symmetrical-resolution halftone tables 52 (altogether 8 in number) around this chosen symmetrical-resolution halftone table.

Next, the computation/conversion module 44 will, by making use of an algorithm, expand the image's corresponding data on the chosen symmetrical-resolution halftone table 5202 along width direction by n times, and, hence, acquire a desired asymmetrical-resolution halftone table 54.

The asymmetrical-resolution printer then goes on to do the pre-print processing of halftoning according to the asymmetrical-resolution halftone table 54 so as to print out ideal images.

The algorithm described above can be an interpolation. The computation/conversion module first picks up from the chosen symmetrical-resolution halftone table 5202 two neighboring pixels, get an average value out of the two pixels' grayscale value, and then interpolate the value between the two pixels. The algorithm can be a B-spline method, too.

The following is an example illustrating the B-spline interpolation method which works with a 5×5 symmetrical-resolution halftone table. Table 4 is the symmetrical-resolution halftone table.

TABLE 4

| | | | | |
|---|---|---|---|---|
| 123 | 10 | 234 | 50 | 22 |
| 30 | 28 | 0 | 190 | 192 |
| 28 | 53 | 87 | 90 | 62 |
| 57 | 184 | 163 | 129 | 102 |
| 58 | 24 | 230 | 254 | 38 |

Converting Table 4 into an asymmetrical resolution halftone table (10×5), we get Table 5.

TABLE 5

| | | | | | | | | | |
|---|---|---|---|---|---|---|---|---|---|
| 123 | 66 | 10 | 122 | 234 | 142 | 50 | 36 | 22 | 72 |
| 30 | 29 | 28 | 14 | 0 | 95 | 190 | 191 | 192 | 111 |
| 28 | 40 | 53 | 70 | 87 | 88 | 90 | 76 | 62 | 45 |
| 57 | 120 | 184 | 173 | 163 | 146 | 129 | 115 | 102 | 79 |
| 58 | 41 | 24 | 127 | 230 | 242 | 254 | 146 | 38 | 48 |

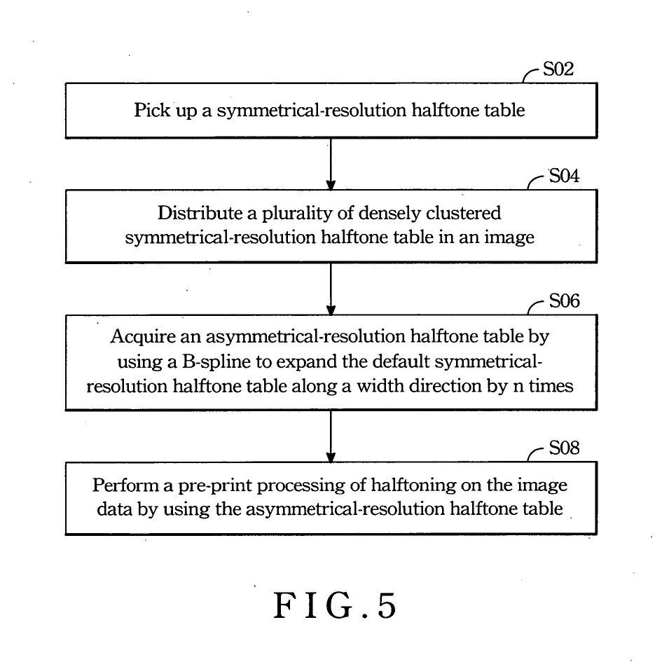

Please refer to FIG. 5. FIG. 5 illustrates the entire process of the image processing method of the present invention's image processing system 32. The halftoning process done by the above image processing system 32 in an asymmetrical-resolution printer to print out corresponding images comprises the following steps:

Step S02: Pick up a symmetrical-resolution halftone table 52

Step S04: Distribute a plurality of densely clustered symmetrical-resolution halftone table 52 (arranged in dot matrices) over an image data's corresponding part in the image 60, and then choose one of them as a default symmetrical-resolution and them picks up it as well as eight neighbor symmetrical-resolution halftone tables 52 thereof.

Step S06: By making use of an algorithm, such as an interpolation. A B-spline is one kind of interpolations, which expand the chosen symmetrical-resolution halftone table 5202 along width direction of the data's corresponding image by n times in order to acquire the desired asymmetrical-resolution halftone table 54.

Step S08: By making use of the asymmetrical-resolution halftone table 54, the system then goes on to do the pre-print processing of halftoning on the image data for the subsequent print out.

Thus, by means of asymmetrical-resolution printer image processing system 32 and image processing method of the present invention, the symmetrical-resolution halftone table 52 is properly converted to the asymmetrical-resolution halftone table 54, by which the printer can do the necessary pre-print processing of halftoning in order to print out quality images.

As is understood by a person skilled in the art, the foregoing preferred embodiment of the present invention is an illustration, rather than a limiting description, of the present invention. It is intended to cover various modifications and similar arrangements included within the spirit and scope of the appended claims, the scope of which should be accorded the broadest interpretation so as to encompass all such modifications and similar structures.

What is claimed is:

1. An image processing method to be used in a printer having an asymmetrical-resolution printing mode to receive image data for printing out an corresponding image according to a halftoning process wherein said asymmetrical-resolution has a aspect ratio n said n=X:Y, the image processing method comprising the Steps of:
picking up a symmetrical-resolution halftone table;
expanding a chosen symmetrical-resolution halftone table along the width direction of said data's corresponding image by n times in order to acquire a asymmetrical-resolution halftone table according to an algorithm; and
using said asymmetrical-resolution halftone table to do said pre-print process of halftoning on said image data for the subsequent printing out of said image.

2. The image processing method as in claim 1, wherein said pre-print process of halftoning is applicable to an AM (Amplitude Modulation) techniques of a laser printer.

3. The image processing method as in claim 1, wherein the system distributes a plurality of densely clustered symmetrical-resolution halftone table over an image data's corresponding part in said image and then picks up a chosen symmetrical-resolution halftone table as well as its neighboring symmetrical-resolution halftone, which are later expanded into an asymmetrical-resolution halftone table by making use of an algorithm.

4. The image processing method as in claim 3, wherein said algorithm is a mathematical interpolation which obtains an average value out of the grayscale values of two neighboring pixels picked up from said chosen symmetrical-resolution halftone table and later interpolated between said two pixels.

5. The image processing method as in claim 3, wherein said algorithm is B-spline method.

6. An image processing system to be used in printers with an asymmetrical-resolution printing mode to receive image data which are halftoned prior to the corresponding image's being printed out, wherein the aspect ratio (n) of said asymmetrical-resolution is n=X:Y and wherein the image processing system comprises:
a computation/conversion module which first picks up a symmetrical-resolution halftone table and then, by making use of an algorithm, expand said chosen symmetrical-resolution halftone table along the width direction of the data's corresponding image by n times in order to acquire an asymmetrical-resolution halftone table; and
wherein by making use of said asymmetrical-resolution halftone table, said asymmetrical-resolution printer do the pre-print process of halftoning on said image data for the subsequent print out of said corresponding image.

7. The image processing system as in claim 6, wherein said pre-print process of halftoning is applicable to the AM(Amplitude Modulation) techniques of laser printers.

8. The image processing system as in claim 6, wherein said image processing system further comprises a placement module which distributes a plurality of densely clustered symmetrical-resolution halftone table over an image data's corresponding part in said image and then picks up a chosen symmetrical-resolution halftone table as well as its neighboring symmetrical-resolution halftone tables, which are later expanded into an asymmetrical-resolution halftone table by making use of an algorithm.

9. The image processing system as in claim 8, wherein said algorithm is a mathematical interpolation which obtains an average value out of the grayscale values of two neighboring pixels picked up from said chosen symmetrical-resolution halftone table and later interpolated between said two pixels.

10. The image processing system as in claim 8, wherein said algorithm is a B-spline method.
